(19) United States
(12) Patent Application Publication
(10) Pub. No.: US 2005/0213468 A1
(43) Pub. Date: Sep. 29, 2005

(54) Method and device for optical recording and optical record carrier

(75) Inventors: Gerardus Rudolph Langereis, Eindhoven (NL); Benno Tieke, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: koninklijke Philips Electronics N.V.

(21) Appl. No.: 10/521,860

(22) PCT Filed: Jul. 24, 2003
(86) PCT No.: PCT/IB03/03325

§ 371 Date: Jan. 21, 2005

(30) Foreign Application Priority Data
Jul. 26, 2002 (EP) 020780656

(51) Int. Cl. G11B 7/00

(52) U.S. Cl. 369/100; 369/275.1

(57) ABSTRACT

The invention relates to a method and device for forming marks and lands by applying a radiation beam to a recording surface of an optical record carrier. During a recording process a reading power level is set in dependence with a recording power level (recording speed). Additionally, cooling gaps are proposed immediately after the recording pulses. The reading during the recording is carried out only for longer lands. The invention relates to a optical record carrier, where the formula for determining the reading power is contained in the control information.

The invention relates to a method of recording information on an optical record carrier, where optically readable marks are formed on the optical record carrier by recording pulses applied to a recording surface of the optical record carrier at a recording power level of an irradiation beam, and where optically readable lands are formed by intervals between the recording pulses at a bias power level of the irradiation beam; where during a recording process the bias power level is set at a reading power level to read pre-recorded information written on the optical record carrier.

The invention also relates to a device for recording information on an optical recording carrier, comprising: recording means for writing a pattern of optically readable marks and lands on the optical record carrier by irradiating a recording surface of the optical record carrier with an irradiation beam; reading means for reading, during a recording process, pre-recorded information written on the optical record carrier and supplying a read signal; processing means for converting input information to be recorded into an output signal supplied to the recording means, the output signal representing the input information and corresponding to recording pulses and intervals between the recording pulses.

The invention further relates to an optical recording carrier susceptible for forming a pattern of optically readable marks and lands by an irradiation beam, comprising a substrate, control information, an information recording area, where the information recording area includes pre-recorded information.

A recording method of the kind set forth in the preamble is known from the Compact Disc Recordable (CD-R) System Description (also known as the Orange Book). When recording data on the CD-R, a read power level is applied between recording pulses in order to sample ATIP (absolute time in pre-groove) information for tracking purposes. As specified in the CD-R standard, the read power level is set at 0.7 mW. The nominal constant linear velocity speed (CLV-speed) of the CD system is between 1.2 to 1.4 m/sec. However, the system is also specified to run at higher speeds, such as, for example, twenty four times the nominal speed (24×). Recording at higher speeds requires that a recording power level for forming marks on a recording surface of the optical record carrier is increased almost proportionally.

It is a drawback of the known method that if the read power level during recording process remains fixed at the 0.7 mW, the dynamic range between recording power level and reading power level becomes very large.

It is an object of the invention to provide a method of optical recording of the kind described in the preamble, which offers reduced dynamic range between recording power level and reading power level.

The object is achieved by a method as described in the preamble which is characterized in that the reading power level is determined by at least one of the parameters: the recording power level and recording speed.

It is found that recording power level is substantially linearly dependent on the recording speed. Therefore, according to the invention, the reading power level during the recording process may be determined as a relative value with respect to the recording power level or an absolute value with respect to the recording speed. A formula where the reading power level depends on both the recording power level and recording speed is also possible, e.g. for different overspeed factors.

It is also found that when a linear dependence between the reading power level and the recording power level is applied, then a scaling factor between 0.02 to 0.2 of the linear dependence results in the acceptable values of the jitter of recorded marks and lands.

For sake of clarity, the power level of an irradiation beam is set at the recording power level during recording pulses for forming marks, whereas during intervals between the recording pulses (i.e. for forming lands) the power level is set at a bias power level.

Increase in the reading power level results in thermal interference effects (that is, pre-heat and post-heat effect). It was found that introducing a cooling gap during intervals between the recording pulses (i.e. setting the bias power level at a cooling power level) immediately after the recording pulse significantly reduces the effects. Additionally, such cooling gaps improve jitter power margins and reduce jitter values. After the cooling gaps the bias power level is set at the reading power level in order to read information pre-recorded on the disc (e.g. ATIP).

The time length of the marks and lands is determined with relation to the time length of T, a one period of a reference clock in a data signal. The time length of the shortest marks and lands is determined by a run-length-limited (RRL) code sequence. For the CD system, the RRL code sequence is the EFM (Eigth to Fourteen Modulation) code sequence resulting in the shortest marks and lands of the time length of 3T. For the recent Blue-ray Disc (BD) system, the shortest marks and lands have time length of 2T.

In practical applications, reading the ATIP information during intervals between the recording pulses for forming the shortest lands is omitted. Therefore, a preferred embodiment is proposed, where for intervals between the recording pulses for forming the shortest lands the bias power level is set only at the cooling power level. On the other hand, for intervals for forming longer lands the bias power level is first set at the cooling power level and then at the reading power level.

The device as described in the preamble is, according to the invention, characterized in that the processing means is arranged to determine a reading power level of irradiation for reading, during the recording process, the pre-recorded information written on the optical record carrier, where the reading power level is determined by at least one of the parameters: the recording power level and recording speed.

In a preferred embodiment, the device is equipped with a storage means for storing a formula for determining the reading power level in dependence with at least one of the parameters: the recording power level and recording speed.

The optical record carrier as described in the preamble, according to the invention, is characterized in that the control information includes a formula for determining a reading power level of the irradiation beam for reading the pre-recorded information during a recording process, where the reading power level is determined by at least one of the parameters: recording power level and recording speed.

In a preferred embodiment, the pre-recorded information is stored in a periodic track modulation of the information recording area, and the frequency of the periodic track modulation is modulated with a digital position-information signal (ATIP).

Although the invention is explained by using a CD-R system as an example, it will be apparent to those skilled in the art that the invention may also be applied to alternative optical recording systems.

The objects, features and advantages of the invention will be apparent from the following, more specific description of embodiments of the invention as illustrated in accompanying drawings; therein:

FIG. 1 shows a diagram of a control signal for controlling the power of the radiation beam for recording marks and lands on the optical recording medium.

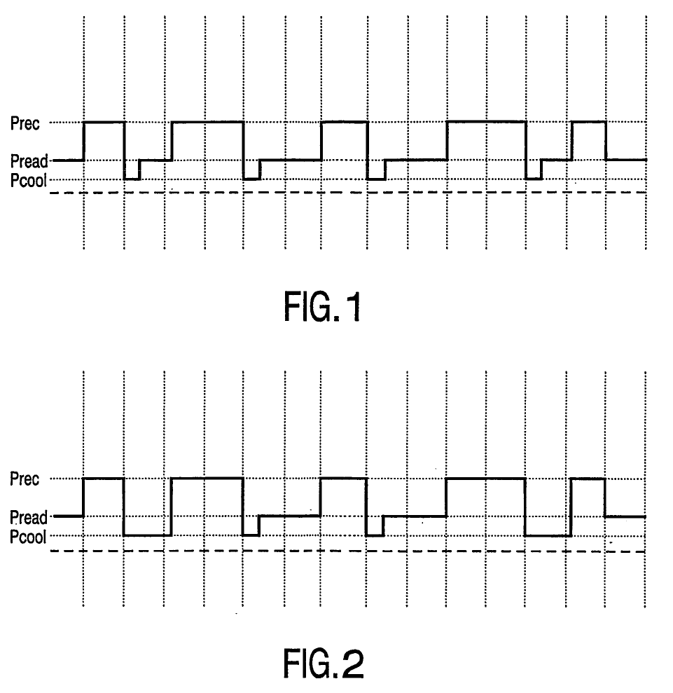

FIG. 2 also shows, in another embodiment, a diagram of a control signal for controlling the power of the radiation beam for recording marks and lands on the optical recording medium.

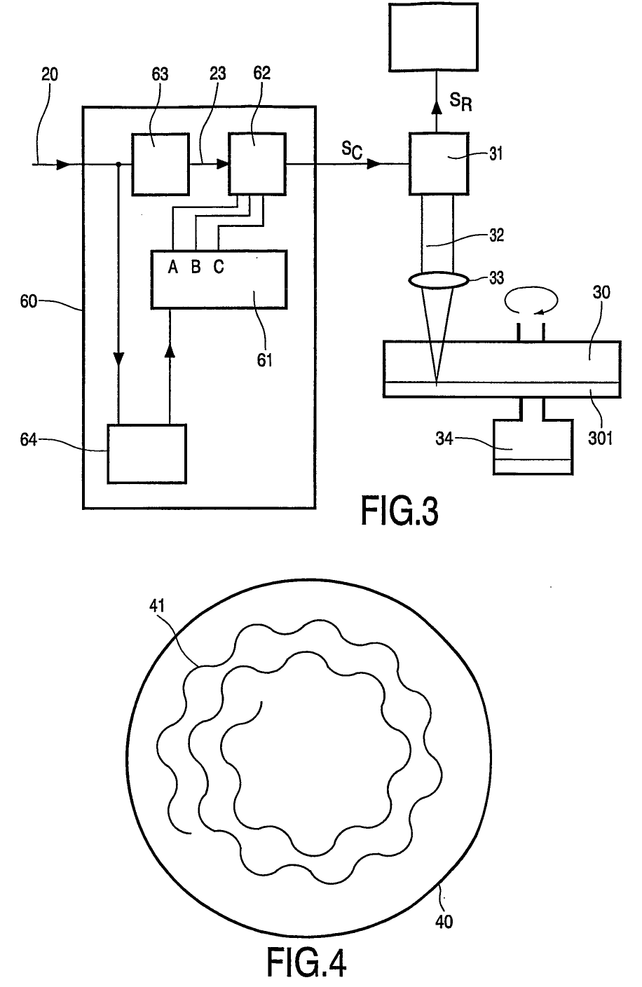

FIG. 3 shows an optical recording device according to the invention

FIG. 4 shows in a plain view an optical recording medium.

FIG. 1 shows a control signal for controlling the power of the radiation beam for recording marks and lands on the optical recording medium. The recording process was performed on a cyanine dye type CD-R disc at the recording speed 24×. When the mark is recorded the control signal, and hence the irradiation power level is set at the recording power level P_{rec} of 34 mW. The reading power level P_{read} during recording process is determined as a fixed value for 24× and equals 6 mW. The cooling power level P_{cool} is set at 0.1 mW. When the lands are formed the control signal, and hence bias power level is first set at the cooling power level for a period of time of 1.5 T and then is set at the reading power level.

FIG. 2 also shows a control signal for controlling the power of the radiation beam for recording marks and lands on the optical recording medium. The recording process was also performed on a cyanine dye type CD-R disc at the recording speed 24×. When the mark is recorded the control signal, and hence the irradiation power level is set at the recording power level P_{rec} of 34 mW. The reading power level P_{read} during recording process is determined for 24× as 12% of the recording power level, and therefore equals to 4 mW. The cooling power level P_{cool} is set at 0.1 mW. The CD-R system run-length-limited code sequence is the EFM modulation, and therefore the shortest marks and lands have the time length of 3T. In this embodiment, when the shortest land was to be formed, the bias power level was set only at the cooling power level, i.e. 0.1 mW. However, if during the recording process the longer lands were to be formed, then the bias power level was first set at the cooling power level for a period of time of 1.5 T and then, for the remaining time needed to form desired land, at the reading power level of 4 mW in order to sample ATIP information.

FIG. 3 shows an optical recording device according to the invention for recording a data signal on the recording surface of a disc-shaped optical record carrier. The optical record carrier is rotated around its center by a motor. A radiation beam is generated by a radiation source and focused onto the recording surface by a lens.

The data signal is connected to processing means 60. A current source within the control means 60 has three outputs A, B and C. Output A provides a current which, when fed to the radiation source through a control signal, will produce the radiation beam having a write power level P_{rec}. Likewise, outputs B and C provide currents resulting in the reading power level P_{read} and the cooling power level P_{cool}, respectively. The current of each output A, B and C can be selected by a switch-unit within the processing means. The switch-unit is operated by a pattern generator controlled by the data signal. The pattern generator transforms the data signal into a control signal. The processing means also comprise setting means for setting the current of the output B of the current source. The current of output B of the current source is set in dependence on the recording power level. The device also comprises a reading means for reading the pre-recorded information written on the disc and supplying the read signal.

FIG. 4 shows an optical recording medium 40 according to the invention in a plain view. The record carrier has a substrate, control information, an information recording area. The control information includes a formula for determining a reading power level of the irradiation beam for reading the pre-recorded information during a recording process. The information recording area includes pre-recorded information in the form of a track pattern comprising a spiral groove 41 of constant width provided with a spiral wobble.

1. A method of recording information on an optical record carrier, where optically readable marks are formed on the optical record carrier by recording pulses applied to a recording surface of the optical record carrier at a recording power level of an irradiation beam, and where optically readable lands are formed by intervals between the recording pulses at a bias power level of the irradiation beam; where during a recording process the bias power level is set at a reading power level to read pre-recorded information written on the optical record carrier characterized in that the reading power level is determined by at least one of the parameters: the recording power level and recording speed.

2. A method as claimed in claim 1, where the reading power level P_{read} is determined by an equation P_{read}=k*P_{rec} where k is a multiplication constant and P_{rec} is the recording power level.

3. A method as claimed in claim 2, where the multiplication constant k is in the range from 0.02 to 0.2.

4. A method as claimed in claim 1, where the bias power level of the intervals between the recording pulses is first set at a cooling power level and then at the reading power level, where the cooling power level is below the reading power level.

5. A method as claimed in claim 1, where the bias power level of the intervals for forming the shortest lands is set at a cooling power level, and where the bias power level of the intervals for forming longer lands is first set at the cooling power level and then at the reading power level; where time length of the lands, expressed in the time length of one period of a reference clock in a data signal, is determined by a run-length-limited code sequence.

6. A device for recording information on an optical recording carrier, comprising:
recording means for writing a pattern of optically readable marks and lands on the optical record carrier by irradiating a recording surface of the optical record carrier with an irradiation beam;
reading means for reading, during a recording process, pre-recorded information written on the optical record carrier and supplying a read signal;
processing means for converting input information to be recorded into an output signal supplied to the recording means, the output signal representing the input information and corresponding to recording pulses and intervals between the recording pulses;
characterized in that the processing means is arranged to determine a reading power level of irradiation for reading, during the recording process, the pre-recorded information written on the optical record carrier, where the reading power level is determined by at least one of the parameters: the recording power level and recording speed.

7. A device as claimed in claim 6, comprising storage means for storing a formula for determining the reading power level in dependence with at least one of the parameters: the recording power level and recording speed.

8. A device as claimed in claim 7, where the storage means comprises a multiplication constant k such that P_{read}=k*P_{rec}, where P_{rec} is the recording power level and P_{read} is the reading power level.

9. A device as claimed in claim 8, where the multiplication constant k is in the range from 0.02 to 0.2.

10. A device as claimed in claims 6, where the recording means is operative to first set the bias power level of the intervals between the recording pulses at a cooling power level and then at the reading power level, where the cooling power level is below the reading power level.

11. A device as claimed in claims 6, where the recording means is operative to set the bias power level of the intervals for forming the shortest lands at a cooling power level, and where the recording means is operative to first set the bias power level of the intervals for forming longer lands at the cooling power level and then at the reading power level; where time length of the lands, expressed in the time length of one period of a reference clock in a data signal, is determined by a run-length-limited code sequence.

12. An optical recording carrier susceptible for forming a pattern of optically readable marks and lands by an irradiation beam, comprising a substrate, control information, an information recording area, where the information recording area includes pre-recorded information, characterized in that the control information includes a formula for determining a reading power level of the irradiation beam for reading the pre-recorded information during a recording process, where the reading power level is determined by at least one of the parameters: recording power level and recording speed.

13. An optical recording carrier as claimed in claim 12, where the pre-recorded information is stored in a periodic track modulation of the information recording area.

14. An optical recording carrier as claimed in claim 13, where the frequency of the periodic track modulation is modulated with a digital position-information signal.

15. An optical recording carrier as claimed in claim 12, where the control information on the substrate comprises a multiplication constant k such that P_{read}=k*P_{rec}, where P_{rec} is the recording power level and P_{read} is the reading power level. 16. An optical recording carrier of claim 15, where the multiplication constant k is in the range from 0.02 to 0.2.
